(19) United States
(12) Patent Application Publication
(10) Pub. No.: US 2002/0097195 A1
(43) Pub. Date: Jul. 25, 2002

(54) Device for actively displaying images on an article

(76) Inventor: Sidney E. Frank, New Rochelle, NY (US)

Correspondence Address: MORGAN & FINNEGAN, L.L.P, 345 Park Avenue, New York, NY, 10154, US

(21) Appl. No.: 09/767,064

(22) Filed: Jan. 22, 2001

(51) Int. Cl. G09G 5/00

(52) U.S. Cl. 345/5

(57) ABSTRACT

A device for actively displaying an image on an article such as a product container comprises a display including an image film, a thin lighting source such as an electroluminescent lamp and optionally an image sequencer, configured to provide backlighting for illuminating the images in response to an electrical signal provided to the lighting source in response to the activation of a switch, optionally including means for producing audible sounds which are synchronized to the sequenced display of images.

### BACKGROUND OF THE INVENTION

The present invention relates to the active display of an image or images on an article such as a beverage or food container or other consumer product or display medium. The invention relates generally to the field of product packaging materials, and more particularly to such packaging materials having sources of illumination and/or sound in order to create special visual and audio effects for displaying products such as those marketed in glass or plastic containers, including food, beverage or personal care items.

This invention pertains to containers for commercial products and the like having various backlighted images provided on their inside or outside surfaces. More particularly, the present invention pertains to containers such as bottles, metallic cans, cardboard boxes and the like, which are provided with an electronic display for showing images thereon, including for example, sequenced images related to the contents of the container, other related products, or even unrelated subject matter. The invention described herein also relates to other consumer products or display media wherein a backlighted and/or sequenced display methodology is implemented.

### DESCRIPTION OF THE PRIOR ART

Beverage or spirit containers such as bottles and cans are typically formed with a cylindrical sidewall and two circular ends made of glass or sheet metal. Typically, the sidewall is provided with a colorfiil label identifying the manufacturer and the contents of the bottle or can. The label is printed on the sidewall of the container itself, or on a paper or plastic sleeve which is then attached to the bottle or can. Additional information may also be provided on the ends of a container including lids or caps.

A major function of the label on spirit or beverage containers is to attract the attention of a potential purchaser. The label can be a powerful advertising medium which can increase sales and revenues. Therefore, manufacturers compete to make their beverage and other containers stand out to attract as much attention as possible.

Thin plastic films, made of polyester or other polymeric material have been used to envelop containers and to otherwise create product wrappings. The use of such polymeric films is widespread due to the fact that such films can be wrapped around an item and heat treated so that it will shrink onto the container being wrapped, thus creating a snug fitting wrapping on the container. This procedure is commonly referred to as “shrink-wrapping.” Shrink-wrapped packaging is particularly advantageous when packaging and displaying two or more items together. The use of such plastic films has also become popular due to the fact that specialized designs and messages can be printed on the exterior of the film to create thematic artwork and messages. The use of such shrink-wrapped packaging materials, however, has limitations. The visual effects that have been available up to the present time have been limited to printed matter, including color images and other specialized designs which are printed on sheets of thin film used as wrappings. It has been common to shrink-wrap thin plastic films onto such items as liquor bottles, soda bottles, iced tea bottles and other drink related or personal care items in order to package such items with other articles. Attracting attention to such packaged goods for more effective marketing is a desirable goal of such merchandising efforts. It would be desirable to create special visual and audio effects with shrink-wrapping, other wrapping materials and product labels that could be capable of attracting the attention of a potential purchaser or to create a more aesthetic appearance or to provide amusement after the product is purchased. U.S. Pat. No. 6,020,823 describes the use of shrink-wrapping to enclose a light emittting diode (LED) between the shrink-wrapped film and a product container to backlight an image on the film. However, there is no description in U.S. Pat. No. 6,020,823 of the use of thin electroluminescent lamps to backlight images or of sequencing the display of images on a film.

U.S. Pat. No. 6,084,526 describes the use of stored data to generate digital images on a display attached to a product container. However, there is no description in U.S. Pat. No. 6,084,526 of the use of thin electroluminescent lamps to backlight images or of sequencing the display of images on a film.

It is accordingly a principal objective of the present invention to provide an active label display for displaying, e.g., high quality color images on a bottle under electronic control, alternately with accompanying audio.

A further objective is to provide an active label display using an electrolumininescent backlighting source.

A still further objective of the present invention is to provide an improved active label display incorporating image sequencing.

An objective of the present invention is to provide a container with a display disposed on a container wall which can show a plurality of images in a variety of sequences.

Yet another objective is to provide a container with a display, speakers and circuitry to provide multimedia presentations including images in a variety of sequence, and sound.

A further object of the present invention is to provide, in combination with a shrink-wrappable plastic film or other package wrap, means for creating audible sounds and illuminated visual effects.

Yet a further, more specific object of the present invention is to provide a shrink-wrapping film that can be used for packaging a variety of articles, including bottles, with means that can be illuminated to create a decorative visual effect when the package is subjected to certain initiating means, such as movement, sound or pressure.

Another object of the invention is to provide a package wrap with devices that produce a variety of audible of sounds or that can be illuminated in order to highlight certain aspects or areas on a decorative design of the package.

Other objectives and advantages of the invention will become apparent from the following description of the invention.

### SUMMARY OF THE INVENTION

A device and method for actively displaying an image or images on an article is provided. The present invention provides for an advance over prior art display methods and systems in the type of backlighting used and in sequencing methodology. Briefly, in one embodiment the invention comprises a container, e.g., a tubular sidewall and two end walls cooperating to form a closed, water and airtight enclosure for a liquid. An active label display is mounted on a container wall. A sleeve is optionally mounted around the tubular wall for constraining the active label display. The active label display is configured to illuminate images on an image film in response to electrical signals generated by a control circuit. The control circuit is mounted on the container as well and includes a controller for generating electrical signals for the display. The control circuit further includes sensors for sensing a predetermined condition. These sensors include a manual ON/OFF switch and/or other elements which detect ambient light, motion, pressure or the opening of the container. The control circuit is responsive to signals from the sensors and activates the display or modifies the display of images in some manner. A battery is also provided for powering the control circuit and the display. Optionally, small speakers may also be provided on the container. The control circuit is optionally adapted to generate sequenced images on the display or, if provided with speakers, may provide a multimedia presentation combining the images with sounds.

The above objects, features and advantages, along with other objects, features, and advantages will become more apparent from the detailed description of the invention in connection with the accompanying drawings to be described more fully hereinafter.

### BRIEF DESCRIPTION OF THE DRAWINGS

FIG. 1 illustrates one embodiment of the invention as manifested in an active display on a bottle.

FIG. 2 provides an exemplary label that can be used in the embodiment of the invention shown in FIG. 1

FIG. 3 is a schematic of one embodiment of the invention illustrating the component interconnections.

FIG. 4 is a side view of one embodiment of the invention showing the physical component orientations.

### DETAILED DESCRIPTION OF PREFERRED EMBODIMENTS

In one embodiment, a product container label or package wrapping for covering a product container includes, e.g., a label attached by adhesive or a shrink-wrappable plastic film and special effects electronic devices, including illuminating devices such as electroluminescent backlighting devices and sound chips which can be positioned between the film and the container and thereby held in place when the film is heated and shrink-wrapped onto the container. A source of electrical energy, such as a battery, is connected to the backlighting devices or sound chip for energizing the backlighting devices or sound ship and causing them to become illuminated or produce certain sounds. Switch means are also provided for connecting the backlighting devices or sound chips with the source of energy when the switch is activated. Illuminating devices or sound producing devices which encapsulate within a housing a backlighting device or sound chip, a source of voltage for energizing the backlighting devices and switch means are all commercially available.

In a preferred embodiment, the active display of the present invention provides numerous functions and features. Display of, e.g., monochromatic or high quality color images on a bottle label under electronic control is facilitated. Display of multiple images with a pre-programmed display sequence on a bottle label is enabled. The design requirements of the active display encompassed herein include electronic design, optical design and packaging design.

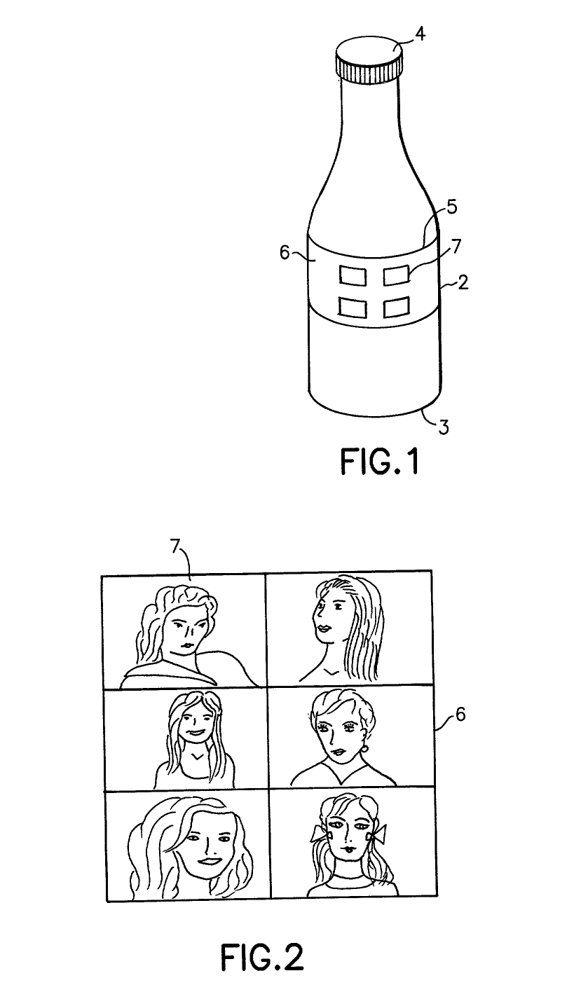

FIG. 1 illustrates one embodiment of the invention as manifested in an active display on a bottle. The bottle 1 is comprised of a side wall 2, an end wall 3 and a lid or cap 4. Attached to the bottle in some manner is an active display 5 including a label 6 which contains at least one image 7. FIG. 2 provides an exemplary image film label 6 that can be used in the embodiment of the invention shown in FIG. 1. Other materials could readily be used as the medium for carrying the image, e.g., plastic sheets, glass etc. It should also be understood that the image may be either on the medium or embedded within it. In this embodiment, the images 7 are partially transparent and/or partially light-transmissible and are responsive to backlighting to increase their visibility. There is flexibility to select the quantity of images, image sizes and image locations on a bottle label to meet particular design requirements. The option exists to mount the active display and label on the front of the bottle or the rear of the bottle (for viewing through the bottle). Thin (<0.1″) and flexible package design allows mounting of the active display on curved surfaces. The active display can be designed to operate continuously by battery power for an extended period of time (depends primarily on image brightness, audio volume and selected battery size). In one embodiment, the active display package design is sealed to prevent damage from any liquid that comes in contact with the bottle.

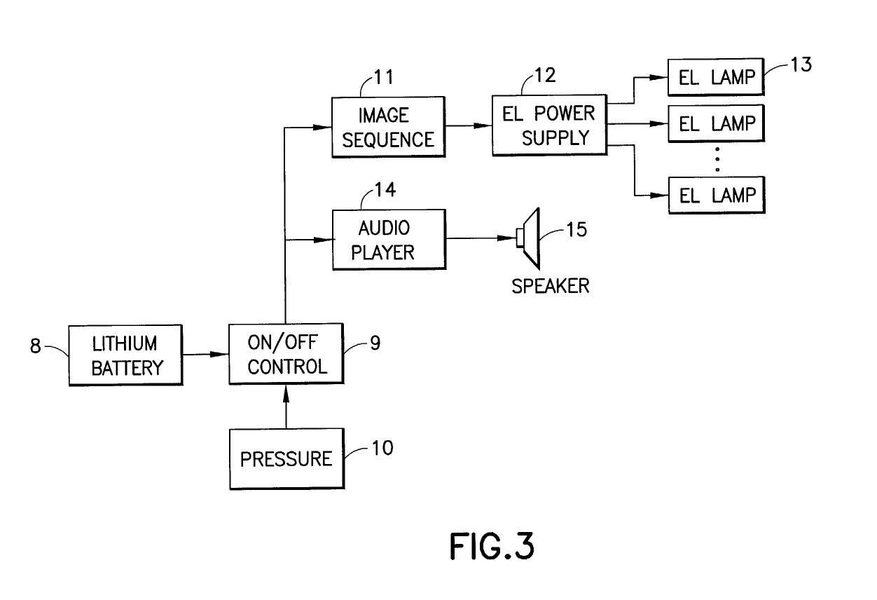

The electronic design of the active display encompassed by the present invention comprises the following main components: electroluminescent (EL) lamps, EL backlight power supply, image sequencer, audio player and ON/OFF control. FIG. 3 provides a block diagram of one embodiment of the active display electronics of the present invention. As shown in FIG. 3, a battery 8, which may be lithium, supplies electrical power to an ON/OFF control switch 9. A pressure switch 10 is also connected to the ON/OF switch 9. Alternatively, the pressure switch 10 and ON/OFF switch 9 could be connected in parallel so that activation of either would energize the system. In any event, power is supplied to an image sequencer 11 which provides output to an electroluminescent power supply 12 which in turn sequentially activates a plurality of electroluminescent lamps 13. An audio player 14 and speaker 15 may also be included. The audio devices may be programmed or configured to produce audible sounds synchronized to the sequenced display of images as the images are lighted by the electroluminescent lamps.

The electroluminescent (EL) lamps 13 are flexible, flat, thin, cold illumination sources that can be manufactured in complex shapes. EL lamps are typically used in applications when a low cost, low power, lightweight source of lighting is required. Typical applications include backlighting for liquid crystal displays (“LCD”) and watch dials. EL lamps are devices that convert electrical energy into light or luminescence; the term luminescence is generally associated with solids that generate light. In the case of electroluminescence, an electric field (voltage) is applied to a thin phosphor layer to produce light. The typical lamp consists of light emitting phosphor sandwiched between two conductive electrodes (one of the electrodes is optically clear to allow light to escape). As an alternating current voltage is applied to the electrodes, the electric field causes the phosphor to rapidly charge and discharge, resulting in the emission of light during each cycle. Since the size and number of light pulses depends on the magnitude of applied voltage and frequency, the brightness of EL lamps can generally be controlled by varying the operating voltage and frequency. The typical EL lamp thickness is <0.02″.

The active display design encompassed herein uses EL lamps to backlight black and white or color images on otherwise transparent film. The size, shape and configuration of the EL lamp is customized to match the image format for a particular display implementation. One EL lamp segment is required for each individually controlled image on a display. Depending on the image configuration, a single EL lamp with electrically isolated segments or multiple individual EL lamps can be selected for a given active display design. EL lamp cost will be affected by the complexity required for a given display design. Where color images are involved, the color of the EL lamp used in the active display contemplated herein should be as close to white as possible. To the extent the EL lamp color is not a true white, the image color can be compensated to optimize the appearance of the image on the display.

The EL lamp intensity is a function of voltage and frequency. The higher the voltage and frequency the brighter the EL lamp. However, increasing the voltage and frequency results in decreased lamp life. Typical lamp life is measured in thousands of hours, therefore decreased lamp life has essentially no impact on an actual active display product. Increased lamp power will decrease the operating life of the display for a given battery size. The actual tradeoffs must be determined as part of the development program for a particular implementation.

The EL lamp power supply is required to generate 80-120 volts a.c. from, e.g., a 3.0 volts d.c. battery. Numerous vendors supply integrated circuit devices for EL lamps used in watch and cell phone applications which are suitable for the applications described herein. The selection of the device depends on the number of external components required, power conversion efficiency, number of lamp output circuits and flexibility to control output voltage and frequency cost. Of course, if a standard off-the-shelf device will not meet the circuit and cost requirements for the active display of the present invention, a suitable device will have to be developed from scratch.

The active display of the present invention requires that multiple EL lamps be turned ON and OFF in some predetermined sequence. To accomplish this, a circuit must be developed to provide a logic output pulse to control each EL lamp associated with an image, control the width of each logic output pulse, and use the logic output pulse to control each EL lamp associated with an image. This image sequencer circuit generally consists of a free running oscillator driving a counter/shift register logic. The logic output pulses can generally all be equal in ON/OFF time, but varied ON/OFF times can be generated if required. Of course, other methodologies for implementing the illumination and sequencing aspects are within the scope of the invention. The design complexity and recurring cost is a direct finction of the number of individual lamps to control and the complexity of the pulse sequence characteristics. It is assumed that standard off-the-shelf devices can be used to meet the circuit and cost requirements for image switching on the active display of the present invention. Of course, if this is not the case, suitable circuits will have to be developed from scratch.

An audio playback device can be optionally integrated into the active display of the present invention. The audio device typically samples and stores a selected audio clip in non-volatile memory. The audio device might, e.g., be designed to play a short audio clip repeatedly while the display is active. The audio device may, e.g., be used to drive a flat, thin piezoelectric speaker. Other audio devices may equally fall within the scope of the invention. The quality of the sound will mainly be a function of the audio playback device. The typical frequency response of a piezoelectric speaker ranges from 500-10000 hz. The typical sample frequency provides for playback of audio up to 3-4 Khz (limiting the sample frequency reduces the memory requirements). It is assumed that standard off-the-shelf devices will provide acceptable audio quality. However, if this is not the case, suitable audio devices will have to be developed from scratch.

An active display in accordance with the present invention is optionally provided with an automatic ON/OFF control circuit. The intention of the circuit is for the label images to become active and/or the sound play whenever a container is moved or the circuit otherwise activated. The active display may deactivate and turn itself off after the bottle becomes stationary again or other deactivation criteria is met. The potential methods for accomplishing this activation/deactivation aspect of the invention include vibration detection and mechanical pressure detection. The vibration detection method would use a monolithic circuit device to detect bottle motion and turn on the active display. The mechanical detection method would use a pressure sensitive switch to detect bottle activity. One option is to place a pressure switch on the bottom of the bottle. When the weight of the bottle or other container is removed from the pressure switch the display turns on. Alternately a pressure switch could be placed on the bottle or other container in an area that would be squeezed when the container is lifted. A significant consideration is the prevention of display activation during shipment causing the batteries to wear out prematurely. The vibration detection method would have the drawback of having to add a method of deactivating the bottle during shipment and then reactivating the bottle. The weighted pressure switch on the bottom of the bottle may be the simplest and lowest cost method.

The optical design of the active display of one embodiment of the present invention involves color image design and filter design. Achieving the optimum color image properties in a particular implementation requires attention to color saturation and color correction. The color saturation of the image has a direct effect on the active display's operating life. Typically, the higher the color saturation the lower the transmission and image brightness. Increasing the backlight intensity to compensate for reduced transmission and image brightness reduces battery life. These are tradeoffs that must be made during the implementation of a particular embodiment to achieve an optimum solution for a particular application.

As mentioned above, EL lamps do not have balanced RED-GREEN-BLUE color components to produce true white. Therefore the color of the images can be optimized to best compensate for the EL lamp color characteristics. Again, this is best determined as part of the design and development process for a particular implementation. Note that the same process will be required if, e.g., liquid in a bottle filters certain colors and the active display images are viewed through the bottle.

The active display's image effect requires that the image not be visible under normal lighting conditions until the EL backlight is switched on. This is accomplished by placing a filter, for example a neutral density filter, over the color image. The transmission characteristics required of the filter are a tradeoff between keeping the image from being visible during normal lighting conditions and the brightness of the image when the EL lamp is energized.

Another filter issue relates to the anti-glare characteristics of the material used. Glare reflected from the surface of a filter material reduces the perceived intensity of the color images. Again, the optimum filter characteristics must be developed as part of the active display product design and development for a particular application.

Printing on the filter may streamline label design in several ways. First, fixed label information can be printed on the front of the filter adding flexibility to the overall bottle labeling design. Secondly, printing images on the rear of the filter may simplify the assembly process.

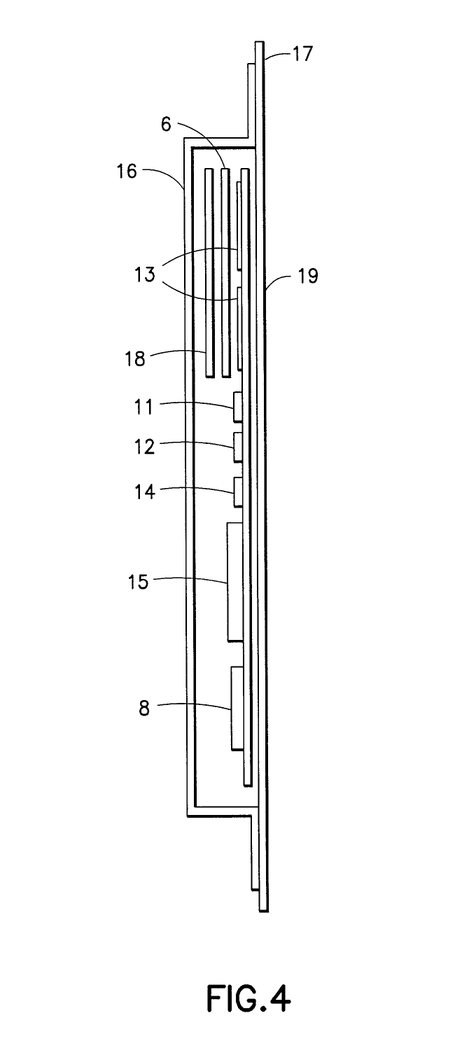

The general package design of one embodiment of the active display of the present invention consists of a stacked arrangement of a front seal, filter, image layer, electronic circuit substrate and rear seal. FIG. 4 illustrates the package design in this embodiment. As can be seen in FIG. 4, the battery 8, speaker 15, electroluminescent lamps 13, image film 6 and various circuit components including an image sequence 11, audio player 14 and electroluminescent power supply 12 are encapsulated by a front seal 16 and a rear seal 17. Also shown in this particular implementation is a neutral density filter 18. When the electroluminescent lamps 13 are energized, they increase the visibility of images on the image film 6 by providing backlighting. The neutral density filter provides optical correction or compensation to improve visibility of the lighted images. The entire package 19 is affixed to an article by known methods such as by adhesive, shrink-wrapping or the like. Alternatively, the working parts could be unsealed and merely shrink-wrapped onto, e.g., a bottle or can.

Primary aspects of one embodiment of the active display packaging design encompassed by the present invention are the development of a thin flexible electronic circuit substrate and the development of a lamination method to assemble and seal the display with minimum impact on optical quality.

The backbone of an active display product encompassed by certain embodiments of the present invention is the electronic circuit substrate. The electronic circuit substrate consists of the etched traces on a flexible circuit board material (typically 0.02″ thick polyester or polyimide). The electronic circuit components (integrated circuits, passive components, EL lamps, battery, etc.) are mounted to the circuit board to create an assembly. The flexible circuit board is designed to the requirements of the custom shape of the particular implementation. The electronic components are mounted to one side of the flexible circuit.

There are two basic methods for mounting the integrated circuits. The first method uses standard leaded integrated circuits soldered to the flexible circuit board. The second uses unpackaged integrated circuit chips directly adhered and sealed to the flexible circuit board. The first method minimizes the engineering time, development and tooling costs of a particular implementation. The second requires additional engineering time and increased development and tooling costs, but should minimize the recurring cost of an active display produced in high volumes. In all likelihood, the first method will be used for prototype and pre-production development. Once the product design has been proven for a particular application, the engineering and tooling costs to implement the second method can be evaluated against potential cost savings.

Active display packaging development may include selection of sealing/laminating materials to enclose the assembly, selection of the lamination technique for the images to the EL lamp and printed circuit board assembly and selection of the lamination technique for attaching the display to the container.

The sealing material should not add glare or loss of image intensity.

Flexing the active display (during attachment to the container) must not cause misalignment of the image layer to the EL lamp positions. The active display should not be readily removable from the bottle. The active display must remain sealed against moisture. The active display packaging design may allow for battery replacement.

Variations of the present device and method that may occur and still fall within the scope of the invention are definition of active display size, shape and location on container; selection of the quantity of images, image sizes and image location; definition of image sequencing requirements, definition of audio requirements and selection of activation method

It is therefore apparent that the described apparatus has inherent advantages over the prior art. While certain preferred embodiments of the invention have been illustrated for the purpose of this disclosure, numerous changes in the arrangement and construction of parts or elements may be made by those skilled in the art, which changes are embodied within the scope and spirit of the present invention as defined by the appended claims.

What is claimed is:

1. A device for actively displaying images comprising: an image film having a plurality of images, a plurality of electroluminescent lamps, at least one battery, a switch for activating the device, an image sequencer and electronic circuitry; wherein the device is configured so that the electroluminescent lamps are activated in response to electrical signals generated by the battery, switch, image sequencer and electronic circuitry such that the electroluminescent lamps provide backlighting for sequentially illuminating the images on the image film.

2. The device of claim 1 wherein the electroluminescent lamps are situated behind the image film.

3. The device of claim 1 wherein a filter is situated in front of the image film, the filter being configured to render the images on the image film substantially nonvisible when the electroluminescent lamps are not activated.

4. The device of claim 3 wherein an outer label is placed over the filter.

5. The device of claim 4 wherein product or other information is printed on the outer label.

6. The device of claim 3 wherein product or other information is printed directly on the filter.

7. The device of claim 1 wherein the device is permanently affixed to a bottle or container for the purpose of actively displaying images on the bottle or container.

8. The device of claim 1 further comprising a means of producing audible sounds.

9. The device of claim 8 wherein the means for producing audible sounds is configured to produce sounds that are synchronized to the sequenced display of images.

10. The device of claim 1 wherein the switch is pressure activated.

11. The device of claim 1 wherein the switch is an ON/OFF switch.

12. The device of claim 1 wherein the switch is motion activated.

13. The device of claim 3 wherein the filter is a neutral density filter.

14. The device of claim 1 wherein the image film is a transparent or translucent flexible plastic.

15. The device of claim 1 wherein the image film is a transparent or translucent rigid plastic.

16. The device of claim 1 wherein the image film is glass.

17. A device for actively displaying images on a container comprising: a container, a display attached to the container, the display including a medium which contains an image, the medium and image both being at least partially transparent or light-transmissible, a plurality of electroluminescent lamps, at least one battery, a switch, an image sequencer and electronic circuitry for connecting the battery, switch, image sequencer and electroluminsescent lamps; wherein the electroluminescent lamps are configured to provide backlighting for sequentially illuminating the images in response to electrical signals generated by the battery, switch, image sequencer and electronic circuitry.

18. The device of claim 17 wherein the medium is a flexible plastic sheet.

19. The device of claim 17 wherein the medium is a rigid plastic sheet.

20. The device of claim 17 wherein the medium is glass.

21. The device of claim 17 further comprising a means for producing audible sounds.

22. The device of claim 21 wherein the means for producing audible sounds is configured to produce sounds that are synchronized to the sequenced display of images.

23. The device of claim 17 wherein the container is a product container.

24. The device of claim 23 wherein the product container is a bottle.

25. The device of claim 17 wherein the switch is pressure activated.

26. The device of claim 17 wherein the switch is motion activated.

27. The device of claim 17 wherein the switch is an ON/OFF switch.

28. The device of claim 17 further comprising a filter placed over the image film to prevent visibility under normal lighting conditions.

29. The device of claim 28 wherein the filter is a neutral density filter.
